(19) United States
(12) Patent Application Publication
(10) Pub. No.: US 2011/0224386 A1
(43) Pub. Date: Sep. 15, 2011

(54) REACTIVE POLYARYLENE ETHER AND METHOD FOR THE MANUFACTURE THEREOF

(76) Inventors: Martin Weber, Maikammer (DE); Christian Maletzko, Altrip (DE); Gerhard Lange, Schriesheim (DE); Jörg Erbes, Karlsruhe (DE); Matthias Dietrich, Weinheim (DE); Nicholas Inchaurrondo, Mannheim (DE); Tobias Kortekamp, Mannheim (DE); Bernd Trotte, Hemsbach (DE)

(21) Appl. No.: 13/130,139

(22) PCT Filed: Nov. 12, 2009
(86) PCT No.: PCT/EP09/65035

§ 371 Date: May 19, 2011

(30) Foreign Application Priority Data
Nov. 20, 2008 (EP) 08169537.1

(51) Int. Cl. C08L 81/06; C08G 75/23; C08L 63/00

(52) U.S. Cl. 525/523; 525/534

(57) ABSTRACT

The present invention relates to a process for the preparation of a polymer composition comprising
(a) the provision of at least one polyarylene ether (P) having predominantly terminal phenolate groups in the presence of a solvent (L),
(b) the addition of at least one polyfunctional carboxylic acid and
(c) the isolation of the polymer composition as a solid.

The present invention also relates to polymer compositions obtainable by the process, mixtures which comprise these polyarylene ethers and the use of the polymer compositions according to the invention for toughening epoxy resins.

The present invention relates to a process for the preparation of a polymer composition comprising
(a) the provision of at least one polyarylene ether (P) having predominantly terminal phenolate groups in the presence of a solvent (L),
(b) the addition of at least one polyfunctional carboxylic acid and
(c) the isolation of the polymer composition as a solid.

The present invention also relates to polymer compositions obtainable by the process, mixtures which comprise these polyarylene ethers and the use of the polymer compositions according to the invention for toughening epoxy resins.

Polyarylene ethers belong to the group consisting of the high-performance thermoplastics and, owing to their high heat distortion resistance and resistance to chemicals, are used in applications exposed to high stress, cf. G. Blinne, M. Knoll, D. Müller, K. Schlichting, Kunststoffe 75, 219 (1985), E. M. Koch, H.-M. Walter, Kunststoffe 80, 1146 (1990) and D. Döring, Kunststoffe 80, 1149 (1990).

It is known from the literature that functionalized polyarylene ethers can be used as tougheners for thermosetting plastic matrices (R. S. Raghava, J. Polym. Sci., Part B: Polym. Phys., 25, (1987) 1017; J. L. Hedrick, I. Yilgor, M. Jurek, J. C. Hedrick, G. L. Wilkes, J. E. McGrath, Polymer, 32 (1991) 2020).

Polyarylene ethers having terminal phenolic groups are preferably used as modifiers in epoxy resins and composite materials. A product widely used for this application is Sumikaexcel® 5003 P from Sumitomo. This product is prepared by condensation of the corresponding monomers in diphenyl sulfone and subsequent purification of the material by extraction with organic solvents. This process is complicated and moreover gives a polymer composition which has a high proportion of terminal phenolate groups and hence of potassium (>700 ppm), which is disadvantageous for the further processing. If such polymer compositions are isolated by precipitation, finely divided precipitates which are complicated to handle for industrial processes then form.

The polyarylene ethers are usually prepared by polycondensation of suitable starting compounds in dipolar aprotic solvents at elevated temperature (R. N. Johnson et. al., J. Polym. Sci. A-1 5 (1967) 2375, J. E. McGrath et. al., Polymer 25 (1984) 1827).

It is furthermore known from McGrath et al., Polymer 30 (1989), 1552, that, after the condensation reaction has taken place, the proportion of terminal amino groups can be reduced by addition of acetic acid during the working-up of polyarylene ethers.

However, additions of acetic acid and mineral acids to polyarylene ethers often lead to discolored products when high temperatures are used, particularly during processing.

An object of the present invention was the provision of reactive, i.e. OH-terminated polyarylene ethers. It was the object of the present invention to avoid said disadvantages of the prior art. It was a further object of the present invention to provide a process for the preparation of OH-terminated polyarylene ethers in which the product is obtained as a precipitate which can be easily handled. The polymer compositions thus obtainable should have high color and thermal stability. In particular, the OH-terminated polyarylene ethers should show as little discoloration as possible on processing in the melt. The process for the preparation thereof should be easy to carry out and should give a high polymer yield.

The abovementioned objects are achieved by the process according to the invention and the polymer compositions according to the invention. Preferred embodiments are described in the claims and the following description. Combinations of preferred embodiments do not depart from the scope of the present invention.

According to the invention, the process for the preparation of polyarylene ethers comprises the following steps in the sequence a-b-c:
(a) provision of at least one polyarylene ether (P) which is composed of building blocks of the general formula I and has predominantly terminal phenolate groups in the presence of a solvent (L)

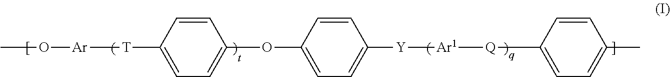

with the following meanings
t, q: independently of one another 0, 1, 2 or 3,
Q, T, Y: independently of one another in each case a chemical bond or group selected from —O—, —S—, —SO₂—, S═O, C═O, —N═N—, —CR^{a}R^{b}—, where R^{a} and R^{b}, independently of one another, are in each case a hydrogen atom or a C₁-C₁₂-alkyl, C₁-C₁₂-alkoxy or C₆-C₁₈-aryl group, at least one of Q, T and Y not being —O— and at least one of Q, T and Y being —SO₂—, and
Ar, Ar¹: independently of one another an arylene group having 6 to 18 carbon atoms,
(b) addition of at least one polyfunctional carboxylic acid and
(c) isolation of the polymer composition as a solid.

In the context of the present invention, terminal phenolate groups are understood as meaning negatively charged oxygen atoms in the form of a terminal group which are bonded to an aromatic nucleus. These terminal groups are derived from the phenolic terminal groups by removal of a proton. In the context of the present invention, phenolic terminal group is understood as meaning a hydroxyl group which is bonded to an aromatic nucleus. Said aromatic nuclei are preferably 1,4-phenylene groups. The polyarylene ethers (P) of the present invention may have firstly terminal phenolate groups or phenolic OH terminal groups and secondly terminal halogen groups.

The polymer composition of the present invention preferably substantially comprises polyarylene ethers having predominantly phenolic terminal groups, i.e. comprising OH-terminated polyarylene ethers.

The term “predominantly terminal phenolate groups” is to be understood as meaning that more than 50% of the terminal groups present are terminal phenolate groups. Accordingly, the term “predominantly phenolic terminal groups” is to be understood as meaning that more than 50% of the terminal groups present are of a phenolic nature.

The proportion of the terminal phenolate groups is preferably determined by determining the terminal OH groups by means of potentiometric titration and determining the organically bound terminal halogen groups by means of atomic spectroscopy and then calculating the respective numerical proportions in %. Corresponding methods are known to a person skilled in the art. Alternatively, the determination of the proportions of the respective terminal groups can be effected by means of ¹³C nucleomagnetic resonance spectroscopy.

In a preferred embodiment (characterized below as “AF-vz”) of the present invention, the provision of the polyarylene ether or of the polyarylene ethers (P) having predominantly terminal phenolate groups in step (a) is effected by reaction of at least one starting compound of the structure X—Ar—Y (A1) with at least one starting compound of the structure HO—Ar1—OH (A2) in the presence of a solvent (L) and of a base (B), where
—Y is a halogen atom,
X is selected from halogen atoms and OH and
Ar and Ar¹, independently of one another, are an arylene group having 6 to 18 carbon atoms.

The preferred embodiments of the individual steps of the process according to the invention are described in more detail below.

According to step (a) of the process according to the invention, at least one polyarylene ether (P) is provided in the presence of a solvent (L), the at least one polyarylene ether (P) being composed of building blocks of the general formula I with the meanings as defined above and having predominantly terminal phenolate groups:

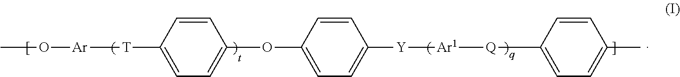

The polyarylene ether (P) preferably has at least 60%, particularly preferably at least 80%, in particular at least 90%, of terminal phenolate groups, based on the total number of terminal groups.

The polyarylene ether (P) is preferably provided in the form of a solution in the solvent (L).

If, under the abovementioned preconditions, Q, T or Y is a chemical bond, this is to be understood as meaning that the neighboring group on the left and the neighboring group on the right are present directly linked to one another by a chemical bond.

Preferably, however, Q, T and Y in formula (II) are selected independently of one another from —O— and —SO₂—, with the proviso that at least one of the group consisting of Q, T and Y is —SO₂—.

If Q, T or Y is —CR^{a}R^{b}—, R^{a} and R^{b}, independently of one another, are each a hydrogen atom or a C₁-C₁₂-alkyl-, C₁-C₁₂-alkoxy or C₆-C₁₈-aryl group.

Preferred C₁-C₁₂-alkyl groups comprise linear and branched, saturated alkyl groups having from 1 to 12 carbon atoms. In particular, the following radicals may be mentioned: C₁-C₆-alkyl radical, such as methyl, ethyl, n-propyl, isopropyl, n-butyl, sec-butyl, 2- or 3-methylpentyl, and relatively long-chain radicals, such as straight-chain heptyl, octyl, nonyl, decyl, undecyl, lauryl and the singly or multiply branched analogs thereof.

Suitable alkyl radicals in the abovementioned C₁-C₁₂-alkoxy groups which can be used are the alkyl groups defined further above and having from 1 to 12 carbon atoms. Cycloalkyl radicals which can preferably be used comprise in particular C₃-C₁₂-cycloalkyl radicals, such as, for example, cyclopropyl, cyclobutyl, cyclopentyl, cyclohexyl, cycloheptyl, cyclooctyl, cyclopropylmethyl, cyclopropylethyl, cyclopropylpropyl, cyclobutylmethyl, cyclobutylethyl, cyclopentylethyl, -propyl, -butyl, -pentyl, and -hexyl, and cyclohexylmethyl, -dimethyl and -trimethyl.

Ar and Ar¹, independently of one another, are a C₆-C₁₈-arylene group. Starting from the starting materials described further below, Ar is preferably derived from an electron-rich aromatic substance which is easily susceptible to electrophilic attack and which is preferably selected from the group consisting of hydroquinone, resorcinol, dihydroxynaphthalene, in particular 2,7-dihydroxynaphthalene, and 4,4′-bisphenol. Art is preferably an unsubstituted C₆- or C₁₂-arylene group.

Suitable C₆-C₁₈-arylene groups Ar and Ar¹ are in particular phenylene groups, such as 1,2-, 1,3- and 1,4-phenylene, naphthylene groups, such as, for example, 1,6-, 1,7-, 2,6- and 2,7-naphthylene, and the arylene groups derived from anthracene, phenanthrene and naphthacene.

Ar and Ar¹ in the preferred embodiment according to formula (I) are preferably selected independently of one another from the group consisting of 1,4-phenylene, 1,3-phenylene, naphthylene, in particular 2,7-dihydroxynaphthalene, and 4,4′-bisphenylene.

Building blocks preferably present within the scope of the polyarylene ether (P) are those which comprise at least one of the following repeating structural units Ia to Io:

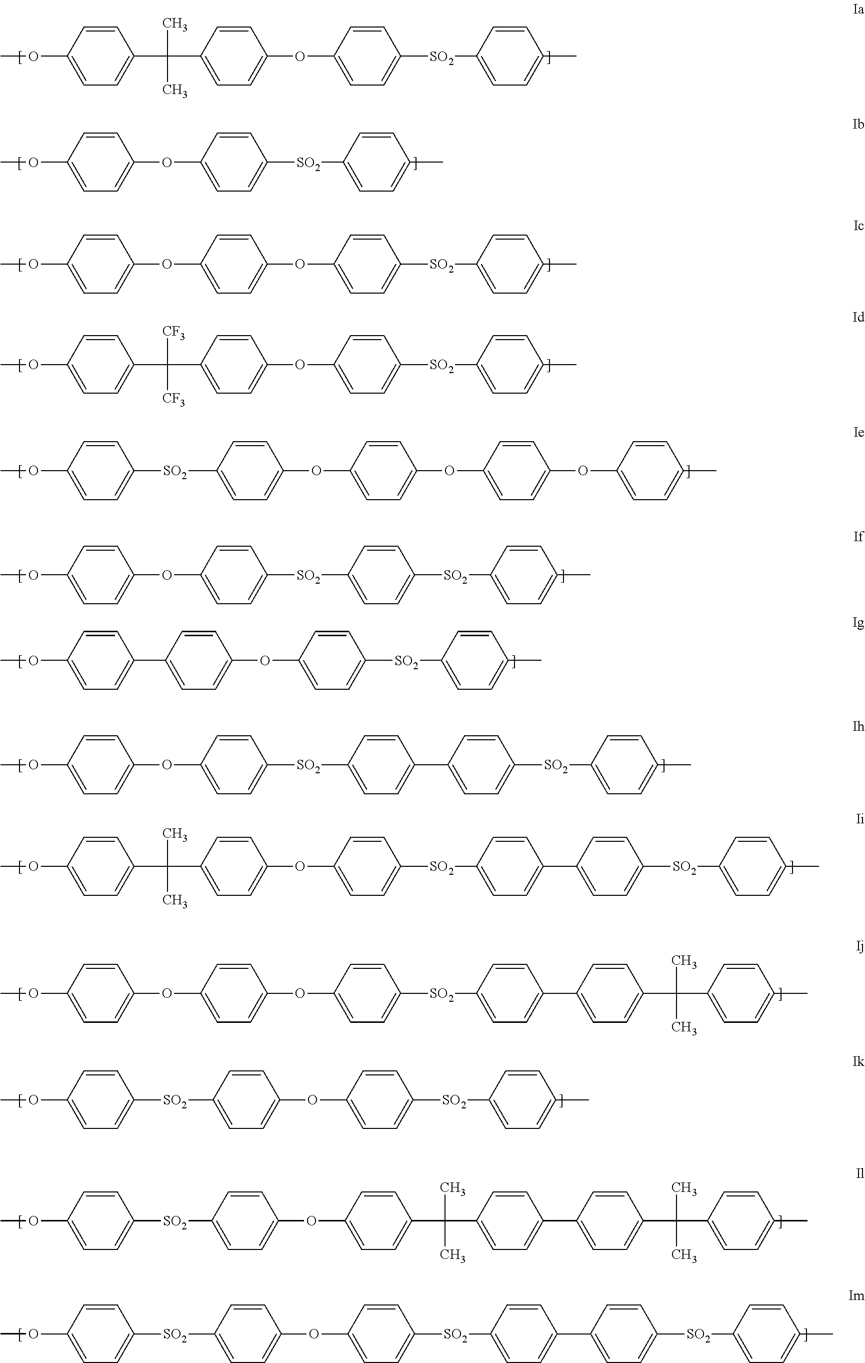

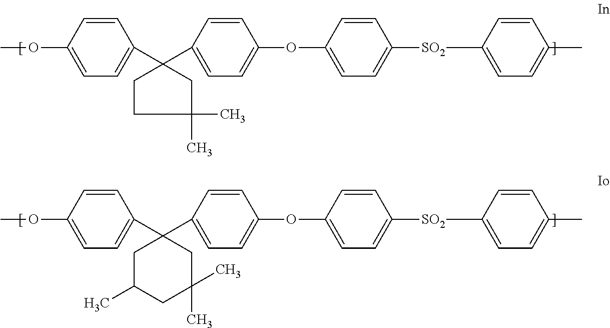

In addition to the preferably present building blocks Ia to Io, those building blocks in which one or more 1,4-dihydroxyphenyl units are replaced by resorcinol or dihydroxynaphthalene units are also preferred.

Particularly preferred building blocks of the general formula I are the building blocks Ia, Ig and Ik. It is also particularly preferred if the polyarylene ethers of the polyarylene ethers (P) are composed substantially of one type of building blocks of the general formula I, in particular of a building block selected from Ia, Ig and Ik.

In a particularly preferred embodiment, Ar is 1,4-phenylene, t is 1, q is 0, T is SO₂ and Y is SO₂. Such polyarylene ethers are designated as polyether sulfone (PESU).

Apart from said repeating building blocks, the structure of the terminal groups is important for the present invention. The polyarylene ethers (P) which are provided in step (a) have, according to the invention, predominantly terminal phenolate groups.

Terminal phenolate groups are converted in the course of the process according to the invention into phenolic terminal groups. In the polymer composition according to the invention, the polyarylene ether therefore has phenolic terminal groups.

Polyarylene ethers having predominantly phenolic terminal groups are referred to below as reactive polyarylene ethers.

The polyarylene ethers (P) preferably have average molecular weights Mₙ (number average) in the range from 2000 to 60 000 g/mol, in particular from 5000 to 40 000 g/mol, determined by means of gel permeation chromatography in the solvent dimethylacetamide against polymethyl methacrylate having a narrow molecular weight distribution as a standard.

The polyarylene ethers (P) preferably have relative viscosities of from 0.20 to 0.95 dl/g, in particular from 0.30 to 0.80. The relative viscosities are measured either in 1% strength by weight of N-methylpyrrolidone solution, in mixtures of phenol and dichlorobenzene or in 96% strength sulfuric acid at in each case 20° C. or 25° C., depending on the solubility of the polyarylene ether sulfones.

The polyarylene ethers (P) described can in principle be provided in various ways. For example, a corresponding polyarylene ether (P) can be brought directly into contact with a suitable solvent and used directly, i.e. without further reaction, in the process according to the invention. Alternatively, prepolymers of polyarylene ethers can be used and can be reacted in the presence of a solvent, the polyarylene ethers (P) described forming in the presence of the solvent.

In a preferred embodiment (AF-vz) of the present invention, the polyarylene ethers (P) are prepared starting from suitable starting compounds, in particular starting from monomers in the presence of a solvent (L) and of a base (B). Such preparation methods are known per se to the person skilled in the art.

In step (a) of this preferred embodiment (AF-vz), the reaction of at least one starting compound of the structure X—Ar—Y (A1) with at least one starting compound of the structure HO—Ar¹—OH (A2) is effected in the presence of a solvent (L) and of a base (B), where
Y is a halogen atom,
X is selected from halogen atoms and OH, preferably from halogen atoms, in particular F, Cl or Br, and
Ar and Ar¹, independently of one another, are an arylene group having 6 to 18 carbon atoms.

The ratio of (A1) to (A2) is chosen so that the number of phenolic terminal groups or terminal phenolate groups exceeds the number of terminal halogen groups.

The preferred embodiments of this preferred embodiment (AF-vz) of the present invention are explained in more detail below.

In stage (a) of this preferred embodiment (AF-vz) of the invention, a polyarylene ether is therefore prepared which is in contact with a solvent (L) and is preferably dissolved therein.

Suitable starting compounds are known to the person skilled in the art and are not subject to any fundamental limitation provided that said substituents are sufficiently reactive in a nucleophilic aromatic substitution. The reaction in step (a) simultaneously is a polycondensation with numerical elimination of hydrogen halide.

Preferred starting compounds are difunctional within the scope of AF-vz. Difunctional means that the number of groups reactive in the nucleophilic aromatic substitution is two per starting compound. A further criterion for a suitable difunctional starting compound is sufficient solubility in the solvent, as described in more detail further below.

Preferred compounds (A2) are accordingly those having two phenolic hydroxyl groups.

It is known to the person skilled in the art that the reaction of the phenolic OH groups is preferably effected in the presence of a base in order to increase the reactivity with respect to the halogen substituents of the starting compound (A1).

Monomeric starting compounds are preferred, i.e. step (a) is preferably carried out starting from monomers and not starting from prepolymers.

A dihalodiphenyl sulfone is preferably used as starting compound (A1). Dihydroxydiphenyl sulfone is preferably used as starting compound (A2).

Suitable starting compounds (A1) are in particular dihalodiphenyl sulfones, such as 4,4′-dichlorodiphenyl sulfone, 4,4′-difluorodiphenyl sulfone, 4,4′-dibromodiphenyl sulfone, bis(2-chlorophenyl) sulfones, 2,2′-dichlorodiphenyl sulfone and 2,2′-difluorodiphenyl sulfone, with 4,4′-dichlorodiphenyl sulfone and 4,4′-difluorodiphenyl sulfone being particularly preferred.

Preferred starting compounds (A2) having two phenolic hydroxyl groups are selected from the following compounds:
dihydroxybenzenes, in particular hydroquinone and resorcinol;

dihydroxynaphthalenes, in particular 1,5-dihydroxynaphthalene 1,6-dihydroxynaphthalene, 1,7-dihydroxynaphthalene and 2,7-dihydroxynaphthalene;
dihydroxybiphenyls, in particular 4,4′-bisphenol and 2,2′-bisphenol;
bisphenyl ethers, in particular bis(4-hydroxyphenyl)ether and bis(2-hydroxyphenyl)ether;
bisphenylpropanes, in particular 2,2-bis(4-hydroxyphenyl)propane, 2,2-bis(3-methyl-4-hydroxyphenyl)propane, and 2,2-bis(3,5-dimethyl-4-hydroxyphenyl)propane;
bisphenylmethanes, in particular bis(4-hydroxyphenyl)methane;
bisphenyl sulfones, in particular bis(4-hydroxyphenyl) sulfone;
bisphenyl sulfides, in particular bis(4-hydroxyphenyl) sulfide;
bisphenyl ketones, in particular bis(4-hydroxyphenyl) ketone;
bisphenylhexafluoropropanes, in particular 2,2-bis(3,5-dimethyl-4-hydroxyphenyl)hexafluoropropane; and
bisphenylfluorenes, in particular 9,9-bis(4-hydroxyphenyl)fluorene.

It is preferable to start from the abovementioned aromatic dihydroxy compounds (A2) to prepare their dipotassium or disodium salts by addition of a base (B) and to react them with the starting compound (A1). The abovementioned compounds can also be used alone or as a combination of two or more of the abovementioned compounds.

Hydroquinone, resorcinol, dihydroxynaphthalene, in particular 2,7-dihydroxy-naphthalene, and 4,4′-bisphenol are particularly preferred as starting compound (A2).

However, it is also possible to use trifunctional compounds. In this case, branched structures form. If a trifunctional starting compound (A2) is used, 1,1,1-tris(4-hydroxyphenylethane) is preferred.

The ratios to be used result in principle from the stoichiometry of the polycondensation reaction taking place with numerical elimination of hydrogen chloride and are established in a known manner by the person skilled in the art. However, an excess of terminal OH groups is preferable for increasing the number of phenolic terminal OH groups.

The preparation of polyaryl ethers with simultaneous control of the terminal groups is known per se to the person skilled in the art and is described in more detail further below. The known polyarylene ethers usually have phenolic halogen terminal groups, in particular —F or —Cl, or phenolic OH or O terminal groups, the latter usually being further reacted in the prior art, in particular to give CH₃O groups.

Various processes are available to the person skilled in the art for establishing the number of phenolic terminal groups.

The ratio of terminal halogen groups to phenolic terminal groups is established in a preferred embodiment by establishing an excess of the difunctional starting compound (A2) in a targeted manner relative to a dihalogen compound as starting compound (A1), i.e. X═Y=halogen.

The molar ratio (A2)/(A1) in this embodiment is particularly preferably from 1.005 to 1.2, in particular from 1.01 to 1.15, very particularly preferably from 1.02 to 1.1.

Alternatively, a starting compound (A1) where X=halogen and Y═OH can also be used. In this case, an excess of hydroxyl groups is established by addition of the starting compound (A2). In this case, the ratio of the phenolic terminal groups used to halogen is preferably from 1.01 to 1.2, in particular from 1.03 to 1.15, very particularly preferably from 1.05 to 1.1.

The conversion in the polycondensation in AF-vz according to step (a) in the preferred embodiment is preferably at least 0.9, with the result that a sufficiently high molecular weight is ensured. If a prepolymer is used as a precursor of the polyarylene ether, the degree of polymerization relates to the number of actual monomers.

Solvents (L) preferred in the present invention are aprotic polar solvents. Suitable solvents moreover have a boiling point in the range from 80 to 320° C., in particular from 100 to 280° C., preferably from 150 to 250° C. Suitable aprotic polar solvents are, for example, high-boiling ethers, esters, ketones, asymmetrically halogenated hydrocarbons, anisole, dimethylformamide, dimethyl sulfoxide, sulfolane and N-methyl-2-pyrrolidone.

A preferred solvent is in particular N-methyl-2-pyrrolidone.

The reaction of the starting compounds (A1) and (a2) is preferably effected in said aprotic polar solvents (L), in particular in N-methyl-2-pyrrolidone.

In the preferred embodiment AF-vz, the reaction of the starting compounds (A1) and (A2) is effected in the presence of a base (B).

The bases are preferably anhydrous. Suitable bases are in particular anhydrous alkali metal carbonate, preferably sodium, potassium or calcium carbonate or mixtures thereof, potassium carbonate being very particularly preferred, in particular potassium carbonate having a volume-weighted average particle size of less than 100 microns, determined using a particle size measuring apparatus in a suspension in N-methyl-2-pyrrolidone.

A particularly preferred combination is N-methyl-2-pyrrolidone as solvent (L) and potassium carbonate as base (B).

The reaction of the suitable starting compounds (A1) and (A2) is carried out at a temperature of from 80 to 250° C., preferably from 100 to 220° C., the upper limit of the temperature being determined by the boiling point of the solvent.

The reaction is preferably effected in a time interval from 2 to 12 h, in particular from 3 to 8 h.

It has proven advantageous to carry out a filtration of the polymer solution after step (a) of the process according to the invention, in particular in the preferred embodiment AF-vz, and before carrying out step (b). The salt fraction formed in the polycondensation and any gel bodies formed are removed thereby.

It has also proven advantageous, in step (a), to set the amount of the polyarylene ether (P), based on the total amount of the mixture composed of polyarylene ether (P) and solvent (L), at from 10 to 70% by weight, preferably from 15 to 50% by weight.

In step (b) of the process according to the invention, at least one polyfunctional carboxylic acid is added to the polyarylene ether (P) from step (a), preferably to the solution of the polyarylene ether (P) in the solvent (L).

“Polyfunctional” is to be understood as meaning a functionality of at least 2. The functionality is the number (if appropriate average number) of COOH groups per molecule. Polyfunctional is understood as meaning a functionality of two or higher. Carboxylic acids preferred in the present invention are di- and trifunctional carboxylic acids.

The addition of the polyfunctional carboxylic acid can be effected in various ways, in particular in solid or liquid form or in the form of a solution, preferably in a solvent which is miscible with the solvent (L).

The polyfunctional carboxylic acid preferably has a number average molecular weight of not more than 1500 g/mol, in particular not more than 1200 g/mol. At the same time, the polyfunctional carboxylic acid preferably has a number average molecular weight of at least 90 g/mol.

Suitable polyfunctional carboxylic acids are in particular those according to the general structure II:

### HOOC—R—COOH (II),

where R is a hydrocarbon radical having 2 to 20 carbon atoms which optionally comprises further functional groups, preferably selected from OH and COOH.

Preferred polyfunctional carboxylic acids are C₄- to C₁₀-dicarboxylic acids, in particular succinic acid, glutaric acid or adipic acid, and tricarboxylic acids, in particular citric acid.

Particularly preferred polyfunctional carboxylic acids are succinic acid and citric acid.

In order to ensure a sufficient conversion of the terminal phenolate groups into phenolic terminal groups, it has proven advantageous to adjust the amount of polyfunctional carboxylic acid or polyfunctional carboxylic acids used in relation to the amount of the terminal phenolate groups.

In step (b) of the process according to the invention, it is preferable to add a polyfunctional carboxylic acid in an amount of from 25 to 200 mol % of carboxyl groups, preferably from 50 to 150 mol % of carboxyl groups, particularly preferably from 75 to 125 mol % of carboxyl groups, determined on the basis of the amount of terminal phenolate groups or phenolic terminal groups.

If too little acid is metered, the precipitation behavior of the polymer solution is inadequate, whereas discoloration of the product may occur during further processing in the event of a substantial overdose.

The amount of terminal phenolate groups or phenolic terminal groups is determined by means of potentiometric titration of the phenolic OH groups on the one hand and determination of the organically bound terminal halogen groups by means of atomic spectroscopy on the other hand, from which the person skilled in the art determines the number average molecular weight and the amount of terminal phenolate groups or phenolic terminal groups present.

In step (c) of the process according to the invention, the polymer composition is isolated as a solid.

In principle, various processes are suitable for the isolation as a solid. However, isolation of the polymer composition by precipitation is preferred.

The preferred precipitation can be effected in particular by mixing the solvent (L) with a poor solvent (L′). A poor solvent is a solvent in which the polymer composition does not dissolve. Such a poor solvent is preferably a mixture of a nonsolvent and a solvent. A preferred nonsolvent is water. A preferred mixture (L′) comprising a solvent with a nonsolvent is preferably a mixture of the solvent (L), in particular N-methyl-4-pyrrolidone, and water. It is preferable to add the polymer solution from step (b) to the poor solvent (L′), which leads to the precipitation of the polymer composition. An excess of the poor solvent is preferably used. Particularly preferably, the addition of the polymer solution from step (a) is effected in finely divided form, in particular in drop form.

If a mixture of the solvent (L), in particular N-methyl-2-pyrrolidone, and a nonsolvent, in particular water, is used as the poor solvent (L′), a solvent:nonsolvent mixing ratio of 1:2 to 1:100 is preferable, in particular from 1:3 to 1:50.

A preferred poor solvent (L′) is a mixture of water and N-methyl-2-pyrrolidone (NMP) in combination with N-methyl-2-pyrrolidone as solvent (L). A particularly preferred poor solvent (L′) is an NMP/water mixture of from 1:3 to 1:50, in particular from 1:4 to 1:30.

The precipitation is effected particularly efficiently if the content of the polymer composition in the solvent (L), based on the total weight of the mixture of polymer composition and solvent (L), is from 10 to 50% by weight, preferably from 15 to 35% by weight.

The purification of the polyarylene ether copolymers is effected by methods known to the person skilled in the art, for example washing with suitable solvents in which the polyarylene ether copolymers according to the invention are for the most part preferably insoluble.

As already described further above, the polymer composition according to the invention substantially comprises the building blocks of the polyarylene ether or of the polyarylene ethers (P) whose predominantly terminal phenolate groups are present as phenolic terminal groups, i.e. OH-terminated.

The proportion of the phenolic terminal groups of the polymer composition of the present process according to the invention is preferably at least 0.1% by weight of OH, calculated as the amount by weight of OH based on the total amount of the polymer composition, in particular at least 0.12% by weight, particularly preferably at least 0.15% by weight.

The determination of the phenolic terminal groups as the amount by weight of OH based on the total amount of the polyarylene ether is effected by means of potentiometric titration. For this purpose, the polymer is dissolved in dimethylformamide and titrated with a solution of tetrabutylammonium hydroxide in toluene/methanol. The end point is determined potentiometrically.

The polymer composition according to the present invention preferably has a potassium content of not more than 600 ppm. The potassium content is determined by means of atomic spectrometry in the present invention.

The present invention furthermore relates to mixtures, preferably reactive resins, in particular epoxy resins, comprising the polymer compositions according to the invention.

Such reactive resins are known to the person skilled in the art and consist of reactive polymers which give a thermosetting plastic of high strength and chemical resistance according to the reaction procedure with addition of suitable curing agents.

The use of the polymer compositions according to the invention for toughening reactive resins, in particular epoxy resins, is preferred.

The following examples explain the invention in more detail without limiting it.

### EXAMPLES

The viscosity number of the polyarylene ethers (P) was determined in 1% strength solution in N-methyl-2-pyrrolidone at 25° C. according to ISO 1628. The proportion of OH groups, too, was determined by potentiometric titration. The proportion of potassium was determined by atomic spectrometry.

The precipitation is assessed according to the following criteria:
discoloration of the precipitating medium NMP/water
turbidity of the precipitating medium 1 minute after the stirrer was switched off
yield of polymer

The precipitation was effected by dropwise addition of a polymer solution having a polymer content of from 20 to 22% by weight into a water/NMP mixture in the ratio 80/20 at room temperature.

For assessing the color stability, the products were heated to 200° C. under air and the resulting change was classified semiquantitatively according to ++, +, 0, − and −−.

### Comparative Example C1

### Synthesis of OH-PES-OH with Mₙ=25 000 g/mol

The polyarylene ether (P-1) was obtained by nucleophilic aromatic polycondensation of 574.16 g of dichlorodiphenyl sulfone, 509.72 g of dihydroxydiphenyl sulfone under the action of 290.24 g of potassium carbonate in 1000 ml of NMP. This mixture was kept at 190° C. for 6 hours under a nitrogen atmosphere. Thereafter, the batch was diluted by addition of 1000 ml of NMP, the solid constituents were separated by filtration and the polymer was isolated by precipitation in 1/4 NMP/water. After careful washing with water, the product was dried under reduced pressure at 120° C. for 12 h. The viscosity number of the product was 55.2 ml/g.

### Example 2

### Synthesis of OH-PES-OH with Mₙ=25 000 g/mol

The polyarylene ether (P-2) was obtained by nucleophilic aromatic polycondensation of 574.16 g of dichlorodiphenyl sulfone, 509.72 g of dihydroxydiphenyl sulfone under the action of 290.24 g of potassium carbonate in 1000 ml of NMP. This mixture was kept at 190° C. for 6 hours under a nitrogen atmosphere. Thereafter, the batch was diluted by addition of 1000 ml of NMP and the solid constituents were separated off by filtration. Thereafter, 5.54 g of succinic acid were added at 80° C. and stirring was effected for 30 minutes. The polymer was then isolated by precipitation in 1/4 NMP/water. After careful washing with water, the product was dried under reduced pressure at 120° C. for 12 h. The viscosity number of the product was 54.9 ml/g.

### Comparative Example C3

### Synthesis of OH-PES-OH with Mₙ=20 000 g/mol

The polyarylene ether (P-3) was obtained by nucleophilic aromatic polycondensation of 574.16 g of dichlorodiphenyl sulfone, 512.09 g of dihydroxydiphenyl sulfone under the action of 290.24 g of potassium carbonate in 1000 ml of NMP. This mixture was kept at 190° C. for 6 hours. Thereafter, the batch was diluted by addition of 1000 ml of NMP and the solid constituents were separated off by filtration. The polymer was then isolated by precipitation in 1/4 NMP/water. After careful washing with water, the product was dried under reduced pressure at 120° C. for 12 h. The viscosity number of the product was 52.5 ml/g.

### Example 4

### Synthesis of OH-PES-OH with Mₙ=20 000 g/mol

The polyarylene ether (P-4) was obtained by nucleophilic aromatic polycondensation of 574.16 g of dichlorodiphenyl sulfone, 512.09 g of dihydroxydiphenyl sulfone under the action of 290.24 g of potassium carbonate in 1000 ml of NMP. This mixture was kept at 190° C. for 6 hours. Thereafter, the batch was diluted by addition of 1000 ml of NMP and the solid constituents were separated off by filtration. Thereafter, 6.2 g of succinic acid were added at 80° C. and stirring was effected for 30 minutes. The polymer was then isolated by precipitation in 1/4 NMP/water. After careful washing with water, the product was dried under reduced pressure at 120° C. for 12 h. The viscosity number of the product was 52.6 ml/g.

### Comparative Example C5

### Synthesis of OH-PES-OH with Mₙ=20 000 g/mol

The polyarylene ether (P-5) was obtained by nucleophilic aromatic polyondensation of 574.16 g of dichlorodiphenyl sulfone, 512.09 g of dihydroxydiphenyl sulfone under the action of 290.24 g of potassium carbonate in 1000 ml of NMP. This mixture was kept at 190° C. for 6 hours. Thereafter, the batch was diluted by addition of 1000 ml of NMP and the solid constituents were separated off by filtration. Thereafter, 8.13 ml of phosphoric acid (85% strength) were added at 80° C. and stirring was effected for 30 minutes. The polymer was then isolated by precipitation in 1/4 NMP/water. After careful washing with water, the product was dried under reduced pressure at 120° C. for 12 h. The viscosity number of the product was 52.4 ml/g.

### Example 6

### Synthesis of OH-PES-OH with Mₙ=20 000 g/mol

The polyarylene ether (P-6) was obtained by nucleophilic aromatic polycondensation of 574.16 g of dichlorodiphenyl sulfone, 512.09 g of dihydroxydiphenyl sulfone under the action of 290.24 g of potassium carbonate in 1000 ml of NMP. This mixture was kept at 190° C. for 6 hours. Thereafter, the batch was diluted by addition of 1000 ml of NMP and the solid constituents were separated off by filtration. Thereafter, 10.1 g of citric acid were added at 80° C. and stirring was effected for 30 minutes. The polymer was then isolated by precipitation in 1/4 NMP/water. After careful washing with water, the product was dried under reduced pressure at 120° C. for 12 h. The viscosity number of the product was 52.6 ml/g.

### Comparative Example C7

### Synthesis of OH-PES-OH with Mₙ=15 000 g/mol, C7

The polyarylene ether (P-7) was obtained by nucleophilic aromatic polycondensation of 574.16 g of dichlorodiphenyl sulfone, 516.07 g of dihydroxydiphenyl sulfone under the action of 290.24 g of potassium carbonate in 1000 ml of NMP. This mixture was kept at 190° C. for 6 hours. Thereafter, the batch was diluted by addition of 1000 ml of NMP and the solid constituents were separated off by filtration. The polymer was then isolated by precipitation in 1/4 NMP/water. After careful washing with water, the product was dried under reduced pressure at 120° C. for 12 h. The viscosity number of the product was 38.3 ml/g.

### Example 8

### Synthesis of OH-PES-OH with Mₙ=15 000 g/mol

The polyarylene ether (P-8) was obtained by nucleophilic aromatic polycondensation of 574.16 g of dichlorodiphenyl sulfone, 512.09 g of dihydroxydiphenyl sulfone under the action of 290.24 g of potassium carbonate in 1000 ml of NMP. This mixture was kept at 190° C. for 6 hours. Thereafter, the batch was diluted by addition of 1000 ml of NMP and the solid constituents were separated off by filtration. Thereafter, 13.1 g of citric acid were added at 80° C. and stirring was effected for 30 minutes. The polymer was then isolated by precipitation in 1/4 NMP/water. After careful washing with water, the product was dried under reduced pressure at 120° C. for 12 h. The viscosity number of the product was 39.4 ml/g.

### Comparative example C9

### Synthesis of OH-PES-OH with Mₙ=15 000 g/mol

The polyaryl ether (P-7) was obtained by nucleophilic aromatic polycondensation of 574.16 g of dichlorodiphenyl sulfone, 516.07 g of dihydroxydiphenyl sulfone under the action of 290.24 g of potassium carbonate in 1000 ml of NMP. This mixture was kept at 190° C. for 6 hours. Thereafter, the batch was diluted by addition of 1000 ml of NMP and the solid constituents were separated off by filtration. Thereafter, 0.81 ml of concentrated HCl were added at 80° C. and stirring was effected for 30 minutes. The polymer was then isolated by precipitation in 1/4 NMP/water. After careful washing with water, the product was dried under reduced pressure at 120° C. for 12 h. The viscosity number of the product was 40.2 ml/g.

### Comparative example C10

### Synthesis of OH-PES-OH with Mₙ=15 000 g/mol

The polyarylene ether (P-7) was obtained by nucleophilic aromatic polycondensation of 574.16 g of dichlorodiphenyl sulfone, 516.07 g of dihydroxydiphenyl sulfone under the action of 290.24 g of potassium carbonate in 1000 ml of NMP. This mixture was kept at 190° C. for 6 hours. Thereafter, the batch was diluted by addition of 1000 ml of NMP and the solid constituents were separated off by filtration. Thereafter, 0.79 ml of 96% strength acetic acid were added at 80° C. and stirring was effected for 30 minutes. The polymer was then isolated by precipitation in 1/4 NMP/water. After careful washing with water, the product was dried under reduced pressure at 120° C. for 12 h. The viscosity number of the product was 39.7 ml/g.

TABLE 1

| | Example | | | | | | | | | |
|---|---|---|---|---|---|---|---|---|---|---|
| | C1 | 2 | C3 | 4 | C5 | 6 | C7 | 8 | C9 | C10 |
| Results of | — | 0 | — | 0 | 0 | 0 | — | 0 | — | — |
| the | | | | | | | | | | |
| precipitation | | | | | | | | | | |
| Discoloration | | | | | | | | | | |
| Turbidity | — | 0 | — | 0 | 0 | 0 | — | — | 0 | 0 |
| Yield [%] | 96.4 | 98.8 | 95.7 | 96.9 | 96.7 | 97.0 | 94.9 | 96.1 | 96.9 | 95.6 |

Results of storage at elevated temperature:

| | | | | | | | | | | |
|---|---|---|---|---|---|---|---|---|---|---|
| Initial color | 0 | + | 0 | + | 0 | + | 0 | + | − | − |
| Color after 24 h at | 0 | 0 | − | 0 | − | 0 | −− | 0 | − | − |
| 200° C. | | | | | | | | | | |
| K content [ppm] | 420 | 280 | 410 | 260 | 470 | 280 | 570 | 310 | 270 | 320 |

Scale from ++ (very good result) to −−− (very poor result)

The polymer compositions of the present invention have a high thermal and color stability. The discoloration and turbidity is substantially reduced compared with the use of acetic acid or mineral acids. The polymer compositions moreover have a substantially reduced proportion of potassium.

1.-15. (canceled)

16. A process for the preparation of a polymer composition comprising the following steps in the sequence a-b-c:
(a) providing at least one polyarylene ether (P) which is compose of building blocks of the general formula I and in which more than 50% of the terminal groups present are terminal phenolate groups in the presence of an aprotically polar solvent (L) 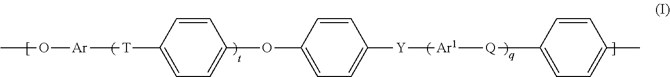
with the following meanings
t and q: independently of one another 0, 1, 2 or 3,
Q, T and Y: independently of one another in each case a chemical bond or group selected from —O—, —S—, —SO₂—, S═O, C═O, —N═N—, and —CR^{a}R^{b}—, where R^{a} and R^{b}, independently of one another, are in each case a hydrogen atom or a C₁-C₁₂-alkyl, C₁-C₁₂-alkoxy or C₆-C₁₈-aryl group, at least one of Q, T and Y not being —O— and at least one of Q, T and Y being —SO₂—, and
Ar and Ar¹: independently of one another an arylene group having 6 to 18 carbon atoms,
(b) adding at least one polyfunctional carboxylic acid and
(c) isolating the polymer composition as a solid.

17. The process according to claim 16, where Ar=1,4-phenylene, t=1, q=0, T=SO₂ and Y═SO₂.

18. The process according to claim 16, at least 80% of the terminal groups of the polyarylene ether or of the polyarylene ethers (P) being terminal phenolate groups.

19. The process according to claim 17, at least 80% of the terminal groups of the polyarylene ether or of the polyarylene ethers (P) being terminal phenolate groups.

20. The process according to claim 16, wherein the providing the polyarylene ether or of the polyarylene ethers (P) in step (a) being effected by reaction of at least one starting compound of the structure X—Ar—Y (A1) with at least one starting compound of the structure HO—Ar¹—OH (A2) in the presence of a solvent (L) and of a base (B), where
—Y is a halogen atom,
X is a halogen atom or OH and
Ar and Ar¹, independently of one another, are an arylene group having 6 to 18 carbon atoms.

21. The process according to claim 16, wherein in step (b) said at least one polyfunctional carboxylic acid is succinic acid or citric acid.

22. The process according to claim 16, wherein the solvent (L) is N-methyl-2-pyrrolidone.

23. The process according to claim 16, wherein in step (c) the isolation of the polymer composition as a solid being effected by precipitation of the polyarylene ether (P).

24. The process according to claim 16, wherein in step (c) the isolation of the polymer composition as a solid being effected by precipitation as a result of the addition of the solution from step (b) to a mixture of water and N-methylpyrrolidone.

25. The process according to claim 16, which further comprises a filtration of the polymer solution being carried out after stage (a) and before stage (b).

26. The process according to claim 16, wherein the amount of the polyfunctional carboxylic acid added being from 25 to 200 mol %, based on the amount of phenolic terminal groups in the polyarylene ether (P).

27. The process according to claim 20, wherein the molar ratio of the starting compounds A2/A1 at the beginning of the reaction according to step (a) being from 1.005 to 1.2.

28. The process according to claim 16, wherein the polyfunctional carboxylic acid having a number average molecular weight of from 90 to 1500 g/mol.

29. A polymer composition obtainable according to the process of claim 16.

30. A mixture comprising a polymer composition according to claim 29.

31. A process for toughening epoxy resins which comprises utilizing the polymer composition according to claim 29 in an epoxy resin.
